(19) United States
(12) Patent Application Publication
(10) Pub. No.: US 2013/0304593 A1
(43) Pub. Date: Nov. 14, 2013

(54) Method for the Creation of a Dynamic Data Record Within a Payment System Environment Application

(71) Applicant: Shaun Iversen, Saskatoon (CA)

(72) Inventor: Shaun Iversen, Saskatoon (CA)

(21) Appl. No.: 13/988,161

(22) PCT Filed: Nov. 16, 2011
(86) PCT No.: PCT/CA2011/050709

§ 371 Date: Jul. 18, 2013

Related U.S. Application Data
(60) Provisional application No. 61/415,454, filed on Nov. 19, 2010.

(51) Int. Cl. G06Q 20/20

(52) U.S. Cl. CPC G06Q 20/204
USPC 705/17

(57) ABSTRACT

A unique and innovative Payment System Environment (PSE) application is described herein. The PSE application, used during the EMV process of Application Selection, is capable of incorporating data from an EMV payment application into a constituent Data Record. The Data Record is said to be dynamic in that the data incorporated may be changed over the life of the EMV payment application. The dynamic Data Record may include a mnemonic that is presented to the cardholder at the time of application selection. The changing of this mnemonic may then prove useful in aiding the cardholder in deciding which application is to be selected for the initiation and processing of an EMV transaction.

### TECHNICAL FIELD

This invention relates to payment transactions effected by integrated circuit cards using the EMV standard. More particularly, the subject matter described herein relates to a method of creating a dynamic Data Record within a Payment System Environment (PSE) application to be utilized during the EMV process of Application Selection when the PSE method is used.

### BACKGROUND

EMVCo creates and manages specifications relating both to Integrated Circuit Cards (ICC) and to the applications which reside on the ICC. The aim of EMVCo is to provide global interoperability between ICC-resident payment applications and Interface Devices (IFD), namely point-of-sale (POS) terminals and automated-teller-machines (ATMs).

Payment applications adhering to the EMV specifications are loaded to ICC, which in turn may be incorporated into any number of form factors, including but not limited to plastic credit cards and debit cards. An ICC loaded with a payment application and incorporated into a form factor may then be presented to an EMV-compliant IFD. An EMV payment transaction may then be initiated. An ICC loaded with one or more EMV payment applications is generally considered to be an improvement upon those credit or debit cards that utilize a magnetic stripe to initiate a payment transaction.

When an ICC is presented to an IFD, power is provided to the chip and the card is said to be activated. It is then necessary for an EMV payment application to be selected. Once selected, the ICC-based payment application, in conjunction with the EMV-compliant IFD, then proceeds through a series of application functions beginning with the Initiate Application Processing function. The mandatory functions are defined within the specifications derived and managed by EMVCo.

Following the Initiate Application Processing function, the next EMV application function undertaken is the process of application selection. The process of application selection is accomplished in two steps. First, a candidate list of mutually supported applications, i.e., applications that are both present within the ICC and are supported by the IFD, is created. Second, a single application is selected from that list either automatically or manually by the cardholder.

The first step, the creation of a candidate list, may be accomplished by one of two methods: the List of AIDs (Application Identifiers) method or the Payment System Environment (P SE) method. The PSE method of EMV Application Selection requires a PSE application, distinct from an EMV payment application, to be present in the ICC, as well as optional support by the IFD. If either the ICC contains no PSE application or the IFD does not support application selection using the PSE method, then the List of AIDs method must be used. Both methods are fully defined within the EMVCo specifications.

The PSE application can be thought of as a specialized application; it is used solely to aid in the EMV process of application selection. Specifically, a PSE application facilitates the subsequent selection of an EMV payment application which, once selected, is used to effect a payment transaction. The PSE application is not an EMV payment application as it can not be used to process an EMV transaction. After the EMV process of application selection is completed the PSE application plays no further role in the processing of an EMV transaction.

During the EMV process of application selection, regardless of which method is used for the process of application selection, an IFD may display a mnemonic to the cardholder. The mnemonic is application-specific and is intended to allow the cardholder to more clearly identify which EMV payment application he or she wishes to use to initiate and process the transaction. A mnemonic display is especially useful when a single ICC contains multiple EMV payment applications. Common examples of mnemonics would include “Debit”, “Credit”, “Savings” and “Chequing”. Often mnemonics refer to the brand associated with the card or application; examples might include “MasterCard Debit” or “Visa Credit”.

It would be advantageous if the mnemonic displayed was not static, that is, if the mnemonic was not the same throughout the lifecycle of the EMV payment application.

A dynamic mnemonic would be comprised of a dynamic component and an optional static component. The dynamic component could be changed such that the dynamic mnemonic displayed to the cardholder was unique or specific to the particular transaction. For example, the dynamic component could be a loyalty balance. This balance, coupled with a static descriptor, could be displayed for example as follows, “LOYALTY $23.45” for one transaction and “LOYALTY $35.02” for a subsequent transaction.

The source of the mnemonic, be it dynamic or static, that may be displayed by the IFD depends on which method is used to create the candidate list of mutually supported EMV payment applications—the List of AIDs method or the PSE method. If the List of AIDs method is used, then the mnemonic is stored within the File Control Information (FCI) of each mutually supported EMV payment application. If however the PSE method is used, then the mnemonic that may be displayed is stored in Data Records within the PSE application.

Paraphrasing footnote 9 from section 12.2.2, p. 138 of EMVCo, Book 1—Application Independent ICC to Terminal Interface Requirements, version 4.2, June 2008, we may note the key difference between the two EMV application selection methods, vis-à-vis the source of the mnemonic,
An IFD building a candidate list using the PSE method will not see the values specified in the FCI of the [payment application] until the application to be run has been chosen. A terminal building the candidate list using the [List of AIDS method] . . . will encounter the values specified in the FCI of the [payment applications].

Due to the different sources and the means by which the mnemonic is provided to the IFD, it is necessary to define distinct, innovative methods for the creation of a dynamic mnemonic.

In European Patent Application No. 09306058.0-1238, filed on Nov. 5, 2009 and sharing the same inventor as the present application, a method is defined for providing a dynamic mnemonic when the List of AIDs method is used during the EMV process of Application Selection. Herein we shall define a method for providing a dynamic Data Record, which may include a dynamic mnemonic, when the PSE method is used during the EMV process of Application Selection,

Additional background information on Integrated Circuit Cards and EMV standards can be found in ISO 7816-4 and EMVCo Books 1-4, version 4.2, June 2008.

### SUMMARY OF THE INVENTION

According to a first aspect of the invention, there is provided a Payment System Environment (PSE) application encoded with logic enabling said PSE application, upon receipt of an APPLICATION SELECT command from an Interface Device (IFD), typically a point-of-sale (POS) or automated teller machine (ATM), in accordance to the EMV process of Application Selection, to update and otherwise change a constituent Data Record to reflect retrieved data from, or stored, or otherwise maintained by an EMV conforming payment application residing within the same integrated circuit card (ICC) as said PSE application.

According to a second aspect of the invention, there is provided a processing device cooperable with an interface device (IFD) to perform an EMV transaction, the processing device comprising a memory in which a Payment System Environment (PSE) application stored, said PSE application comprising logical instructions executable to enable said PSE application, upon receipt of an APPLICATION SELECT command from the Interface Device (IFD) in an EMV Application Selection process, to modify a constituent Data Record to reflect retrieved data associated with a payment application of said processing device that conforms to EMV standards.

According to a third aspect of the invention, there is provided a method of providing dynamically updated data in an EMV Application Selection process between a processing device and an interface device (IFD) cooperable therewith, the method comprising receipt of an APPLICATION SELECT command from the Interface Device (IFD) by a Payment System Environment (PSE) application on the processing device, retrieving data associated with a payment application of said processing device, and modifying a constituent Data Record of said PSE application to reflect said retrieved data.

According to a fourth aspect of the invention, there is provided a method of providing a dynamic application mnemonic in an EMV transaction between a processing device and an interface device (IFD) cooperable therewith, the method comprising receipt of an APPLICATION SELECT command from the Interface Device (IFD) by a Payment System Environment (PSE) application on the processing device during an EMV Application Selection process, retrieving data associated with a payment application of said processing device, modifying a constituent Data Record of said PSE application to reflect said retrieved data; and issuing the modified Data Record to the IFD in a READ RECORD response in accordance with the EMV Application Selection process.

The Data Record may be updated or otherwise changed by altering any of the data elements comprising said Data Record.

Preferably the PSE application gathers data from an EMV payment application.

Preferably a GET DATA command, identifying the data which is to be retrieved, is sent from the PSE application to the EMV Payment application.

The method of gathering data recited in Claim 4 wherein a GET DATA response, which includes the data identified in the associated GET DATA command, is received from the EMV payment application by the PSE application.

Preferably the PSE application formats data retrieved from the EMV payment application.

Preferably the formatting includes at least one of the addition or deletion of characters to or from the data retrieved by the PSE application.

The formatting may include the concatenation of the data retrieved from an EMV payment application with static data that is stored or otherwise maintained by the PSE application, or with data that has been previously retrieved from an EMV payment application by the PSE application.

Preferably the PSE application determines the length of formatted data.

Preferably the length determination includes the comparison of the determined length of the formatted data to a defined maximum and/or minimum value.

Preferably the length determination includes the continued formatting of data until an acceptable result is achieved in the length comparison step of the preceding paragraph.

Preferably the PSE application creates a Tag-Length-Value (TLV) data element by the concatenation of a Tag component, a Length component and a Value component.

Preferably the TLV data element creation includes the determination of a Tag component which is equal to a predetermined value associated with the data element in accordance to the EMV standards.

Preferably the TLV data element creation includes the determination of a Length component which is equal to the length of the Value component.

Preferably the TLV data element creation includes includes the determination of a Value component which is equal to the formatted data.

Preferably the PSE application incorporates the TLV data element into a Data Record.

Preferably the incorporation of the TLV data element into the Data Record includes the replacement of any existing TLV data element in the Data Record with the TLV data element being incorporated if said TLV data elements have the same Tag component.

The incorporation of the TLV data element into the Data Record may include the changing of length parameters within the Data Record to accurately reflect the new length of the TLV data element being incorporated.

Preferably the length parameters being changed are those associated with the Application Template (EMV tag ‘61’) and the Payment System Directory Record (EMV tag ‘70’).

The PSE application may gather data from multiple EMV payment applications.

The PSE application may format data retrieved from multiple EMV payment applications.

The PSE application may create multiple Tag-Length-Value (TLV) data components.

The PSE application may incorporate multiple Tag-Length-Value (TLV) data components into multiple Data Records.

### BRIEF DESCRIPTION OF THE DRAWINGS

FIG. 1 is a block diagram illustrating a sample transaction environment according to an embodiment of the subject matter defined herein; and

FIG. 2 is a flow diagram illustrating the steps of an exemplary process according to an embodiment of the subject matter defined herein; and

FIG. 3 schematically depicts an instance of a dynamic mnemonic being displayed on a point-of-sale terminal which is utilizing the PSE method to effect the EMV process of application selection according to an embodiment of the subject matter defined herein.

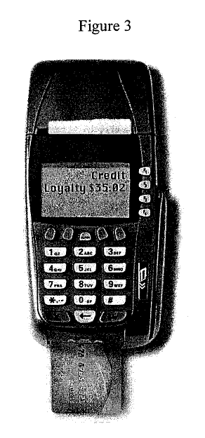

### DETAILED DESCRIPTION OF THE INVENTION

To further aid the cardholder during the EMV process of Application Selection, there is a need to provide a dynamic mnemonic, one that is not constant or static over the life of the EMV payment application. When the PSE method is used to compile the candidate list of mutually supported EMV payment applications, the PSE application will include functionality to create and manage a dynamic Data Record which includes at least one dynamic data element, one of which may define a dynamic mnemonic. An innovative method in support of such functionality is defined within this specification.

A PSE application that supports the ability to dynamically alter, or update, its constituent Data Records shall be referred to herein as a Dynamic PSE application. A Dynamic PSE application will interact with an IFD in the exact same manner as a standard PSE application that does not support the ability to dynamically alter its Data Records. If an EMV-compliant IFD, be it a POS or an ATM, supports the PSE method, then the IFD shall not be able to distinguish between a Dynamic PSE application and a standard PSE application. All functionality pertaining to the support of dynamic PSE Data Records shall be carried out within the ICC; no dedicated or specialized terminal functionality is required.

Demonstrating by way of an example, let us presuppose the existence of an ICC which contains a Dynamic PSE application as well as two EMV payment applications, App#1 and App#2. It is desired to have a dynamic mnemonic associated with App#1 only. App#2 will be represented by a standard, non-changing mnemonic. Other applications may also be loaded to the ICC, however these applications are not represented by Data Records within the Dynamic PSE application; such applications could only be selected via the List of AIDs method and are not of interest for this specification.

The Dynamic PSE application will contain two Data Records. Data Record #1 will contain those parameters associated with App#1, including a dynamic mnemonic. Data Record #2 will contain those parameters associated with App#2, including a static, unchanging mnemonic.

Each Data Record within the Dynamic PSE application is identified by a Payment System Directory Record tag, equal in value to ‘70’ (hex), followed by a record length value. The length value is in turn followed by an Application Template tag, equal in value to ‘61’ (hex), followed by a template length value. Note that single quotation marks denote a hexadecimal value.

Below we see a presentation of the two Data Records that would be present within the Dynamic PSE application for our example. The body of the first Data Record is comprised of four data elements (identified by tags ‘4F’, ‘50’, ‘9F12’ and ‘87’), each followed by a tag length value and then a value for the tag itself. The data elements are said to be in Tag-Length-Value (TLV) format. The body of the second Data Record is comprised of only two data elements (‘4F’ and ‘50’).

| | |
|---|---|
| 70 22 | Payment System Directory Record tag, |
| | length of ‘27’ |
| 61 20 | Application Template #2, tag ‘61’, |
| | length of ‘20’ |
| 4F 07 A0000000041010 | AID#1 tag, length of ‘07’ |
| 50 0A 4D617374657243617264 | App Label, tag ‘50’, “MasterCard”, |
| | length of ‘0A’ |
| 9F12 05 4170702331 | App Pref Name, tag ‘9F12’, “App#1”, |
| | length of ‘05’ |
| 87 01 81 | App Priority Indicator, tag ‘87’, length |
| | of ‘01’ |
| 70 12 | Payment System Directory Record tag, |
| | length of ‘12’ |
| 61 10 | Application Template #2, tag ‘61’, |
| | length of ‘10’ |
| 4F 07 A0000000031010 | AID#2, tag ‘4F’, length of ‘07’ |
| 50 05 4170702332 | App Label, tag ‘50’, “App#2”, length |
| | of ‘05’ |

We see above that changing the length of any of the data elements within the body of either Data Records will in turn change the lengths of both the Application Template, tag ‘61’, and the Payment System Directory Record, tag ‘70’, for that specific Data Record. For example, suppose the Application Preferred Name, tag ‘9F12’, associated with App#1 and located in the first Data Record above, was changed from “App#1” to say “App#1 $531.22”. That is, 8 additional characters (a space, a dollar sign, a five and so on) have been appended. The length of the Application Preferred Name tag would therefore change from ‘05’ to ‘OD’ (the hexadecimal representation of thirteen). This in turn would impact the length values of both the Application Template and Payment System Directory Record, tags ‘61’ and ‘70’ respectively, with each being increased by eight. The resulting PSE record for App#1 would be as follows (changed items are bolded):

| | |
|---|---|
| 70 2A | Payment System Directory |
| | Record tag, length of ‘2A’ |
| 61 28 | Application Template #2, tag |
| | ‘61’, length of ‘20’ |
| 4F 07 A0000000041010 | AID#1 tag, length of ‘07’ |
| 50 0A 4D617374657243617264 | App Label, tag ‘50’, |
| | “MasterCard”, length of ‘0A’ |
| 9F12 0D 4170702331203533312E3232 | App Pref Name, tag ‘9F12’, |
| | “App#1 $531.22” |
| 87 01 81 | App Priority Indicator, tag |
| | ‘87’, length of ‘01’ |

Above we see that tag ‘9F12’, the Application Preferred Name, is the sole dynamic data element located in the dynamic Data Record. It is possible that other tags within the dynamic Data Record could be dynamic, or that multiple tags could be altered. Similarly, multiple Data Records could be dynamic with one or more dynamic data elements in each.

As per EMV specifications, the mnemonic that may be displayed to a cardholder during the EMV process of Application Selection may be either the Application Preferred Name, tag ‘9F12’, if present, or the Application Label, tag ‘50’, which must always be present. For our purposes, it shall make no difference which tag, the Application Preferred Name or the Application Label, is designated as intended to reflect a dynamic mnemonic. Both the Application Preferred Name and the Application Label are limited to a maximum of 16 characters.

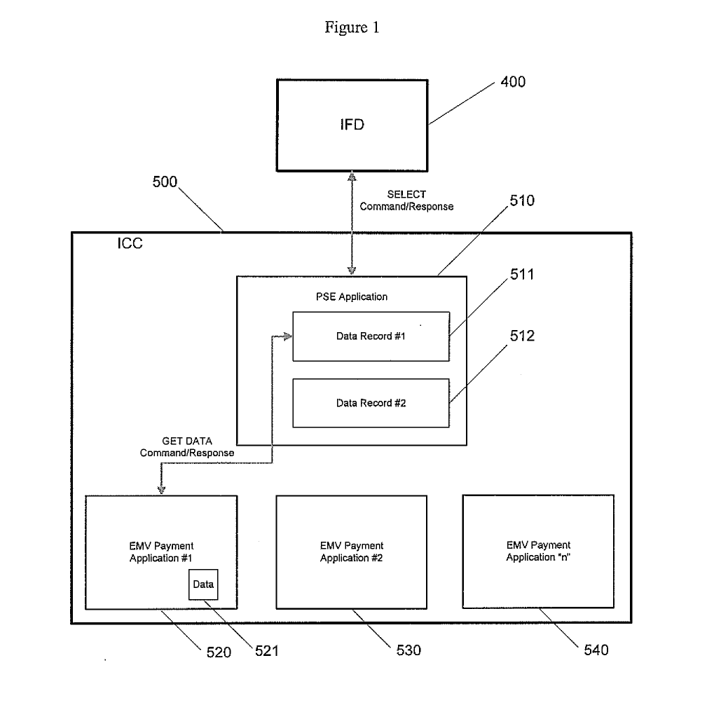

FIG. 1 depicts an environment in which the innovative method may be deployed.

An ICC (500) is loaded with a Dynamic PSE application (510) and multiple EMV payment applications (520, 530 and 540). In a conventional manner, the ICC includes a microprocessor, and memory coupled thereto in which the applications are stored for execution of their logical instructions by the microprocessor. Application #1 is represented in the Dynamic PSE application by Data Record #1 (511), while application #2 is represented by Data Record #2 (512). In this example, only Data Record #1 is to be dynamically updated. Data Record #2 is static and will remain the same throughout the life of the ICC. EMV payment application #1 contains a tag (521) that stores data. This data is expected to change throughout the life of the EMV payment application; the value stored within the tag may be changed by the EMV payment application during normal processing of an EMV transaction, or it may be provided to the EMV payment application by means of scripting (another EMV application function).

All other EMV payment applications (540) present within the ICC are not represented by Data Records within the Dynamic PSE application; as such, these EMV payment applications will only be capable of being selected via the List of AIDs method; such applications are not relevant to this example. Similarly, non-EMV applications (not shown) may be present within the ICC; such applications would not be represented by Data Records within the Dynamic PSE application and are not relevant to this specification.

The ICC (500) is presented to an EMV-compliant IFD (400), commonly either a POS terminal or an ATM, which supports the PSE application selection method. The ICC is powered up and reset (returning an Answer-to-Reset) in accordance to EMV specifications. After the ICC is reset, a SELECT command is sent from the IFD to the ICC. The SELECT command will contain a data component equal to ‘1PAY.SYS.DDF01’, which is the AID of the PSE application, indicating that the PSE application is to be selected.

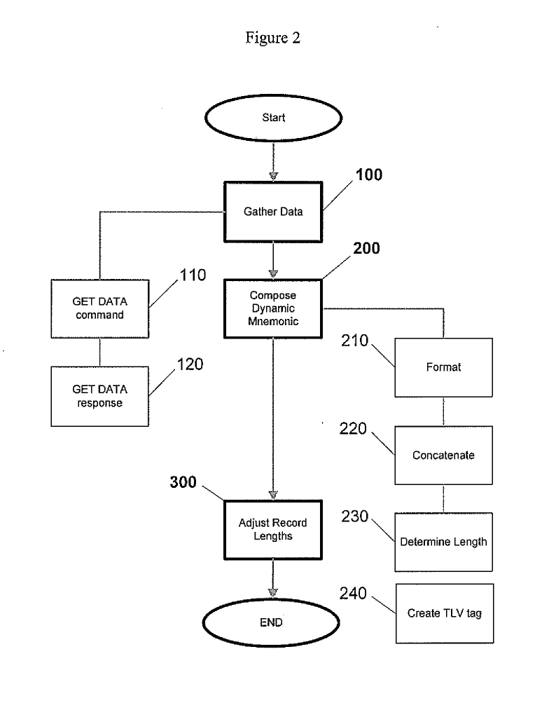

The PSE application is thus selected and returns its File Control Information (FCI) to the IFD. The FCI of the PSE application includes a Short File Identifier (SFI) indicating to the IFD where to commence reading records. The IFD then sends a series of READ RECORD commands to the PSE application. Prior to returning a response to the READ RECORD commands, the PSE application will execute the steps as detailed in FIG. 2.

First, step 100, the PSE application must gather the data necessary to compose the dynamic Data Record. The PSE application will send a GET DATA command (110) to EMV payment application #1. The GET DATA command will contain a data component equal to the tag value under which the desired data is stored within EMV payment application #1. EMV application #1 will then return to the PSE application a GET DATA response (120), which includes the value of the data presently stored in the tag indicated in the data component of the GET DATA command. The value stored within this tag is presumed to change over the life of EMV payment application #1.

Next, step 200, the PSE application must then take the data that is returned in response to the GET DATA command and compose the dynamic Data Record.

Formatting (210) puts the retrieved data in a desired format; formatting may include the addition or deletion of characters. For example, a denomination indicator such as “$” or “£” or “¥” may be appended. Similarly, a decimal may be inserted, or characters following a decimal point may be deleted. Formatting is an optional step, as the format in which the data is originally stored within the source EMV payment application may be the same as the desired final format.

Concatenating (220) the formatted data with known static data is also optional, as there may be no static data. The static data is known to the PSE application and is generally stored within the PSE application. It is possible that static data is stored within an EMV payment application; however, if that is the case, then an additional GET DATA command would need to be sent from the PSE application. The static data, while included in the dynamic data element, does not, by definition, change from instance to instance. Examples of static data would include a static descriptor such as “Balance”. The optional static data, together with the dynamic, formatted data, comprise the value component of the dynamic data element. Furthermore, it is possible that the dynamic data element is comprised of multiple dynamic data components; again, multiple GET DATA commands would be necessitated. It is possible that multiple GET DATA commands could be sent to a single EMV payment application requesting data from multiple tags, or multiple GET DATA commands could be sent to multiple EMV payment applications.

Determining the Length (230) is done in conjunction with formatting. Each tag has a predetermined maximum length. In our previous example, the Application Preferred Name, tag ‘9F12, in agreement with EMV specifications, must not exceed 16 characters. Since the length of the static data is known, and constant, it is possible to determine that the maximum length of the formatted dynamic data must not be greater than 16 less the length of the static data. In this case, if the length of the dynamic data element is greater than 16 characters, then additional formatting must be undertaken.

Next, the tag-length-value (TLV) data component must be created (240). Generally the tag component will be either ‘9F12’ or ‘50’, though any tag located in the dynamic Data Record may be altered. The length component will be the length of the formatted Dynamic Mnemonic, which must be less than 16 (‘10’ hex). The value component will be the Dynamic Mnemonic itself.

The TLV data will then be incorporated into the designated Data Record, in this case Data Record #1, within the Dynamic PSE application.

Finally, step 300, involves ensuring that the length parameters within the updated Data Record accurately reflect the new length of the updated TLV data for the dynamic data element. Typically this involves verifying, and possibly changing, the length components of both the Application Template (tag ‘61’) and the Payment System Directory Record (tag ‘70’) for the dynamic Data Record. It is possible that, even though the dynamic values have changed, the newly created dynamic data element is of the same length as the previous value of the dynamic data element and therefore the lengths of tags ‘61’ and ‘70’ do not change. It is still necessary to verify and confirm these lengths.

Although not accounted for in FIG. 2, the number of times that each step must be performed is equivalent to the number of dynamic data elements present within the dynamic Data Records that that are intended to be provided to the IFD. If two dynamic data elements are desired, then each step would need to be carried out twice. If three dynamic data elements, then three times, and so on.

After step 300, the Dynamic PSE application is capable of returning the desired responses, which include the dynamic Data Record, to the IFD. The IFD will then process and interpret the individual data elements, each represented by a tag value, in accordance to EMV specifications. Since we have provided a method for altering the tag values from one transaction to the next, it follows that the IFD may therefore behave differently based upon these different values. In our example where tag ‘9F12’, the Application Preferred Name, was altered, the mnemonic that may be displayed to the cardholder to aid in application selection is changed. Once the selection is made by the cardholder, the IFD then sends a SELECT command directly to the intended payment application and the EMV transaction is commenced. The PSE application plays no further role in the transaction once all Data Records have been read.

Steps 100, 200 and 300 may be executed at any time after the Dynamic PSE application has received an APPLICATION SELECT command. They must however be completed prior to the Dynamic PSE application returning to the IFD, in response to a READ RECORD command, a Data Record which includes a dynamic data element.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A processing device cooperable with an interface device (IFD) to perform an EMV transaction, the processing device comprising a memory in which a Payment System Environment (PSE) application is stored, said PSE application comprising logical instructions executable to enable said PSE application, upon receipt of an APPLICATION SELECT command from the Interface Device (IFD) in an EMV Application Selection process, to modify a constituent Data Record of the PSE application to reflect retrieved data associated with a payment application of said processing device that conforms to EMV standards.

2. The processing device recited in claim 1 wherein said PSE application is configured so that said Data Record is modified by altering any one or more of data elements that comprise said Data Record.

3. The processing device recited in claim 1 wherein said PSE application is configured so that said Data Record, once updated, is returned to the IFD in a READ RECORD response in accordance to the EMV Application Selection process.

4. The processing device recited in claim 1 wherein said PSE application is configured to gather data from an EMV payment application coresident within said processing device.

5. The processing device recited in claim 4 wherein said PSE application is configured so that a GET DATA command, identifying the data which is to be retrieved, is sent from the PSE application to the EMV Payment application coresident within said processing device.

6. The processing device recited in claim 4 wherein said PSE application is configured so that a GET DATA response, which includes the data identified in the associated GET DATA command, is received from the EMV payment application by the PSE application.

7. The processing device recited in claim 1 wherein said PSE application is configured to format data retrieved from an EMV payment application.

8. The processing device recited in claim 7 wherein said PSE application is configured so that formatting the data retrieved from the EMV payment application includes at least one of addition or deletion of characters to or from the data retrieved by the PSE application.

9. The processing device recited in claim 7 wherein said PSE application is configured so that formatting the data retrieved from the EMV payment application includes concatenation of the data retrieved from the EMV payment application with static data that is stored or otherwise maintained by the PSE application, or with data that has been previously retrieved from the EMV payment application by the PSE application.

10. The processing device recited in claim 7 wherein said PSE application is configured to determine a length of the formatted data.

11. The processing device recited in claim 10 wherein said PSE application is configured to compare the determined length of the formatted data to at least one of a predefined maximum or minimum value.

12. The processing device recited in claim 11 wherein said PSE application is configured to repeat formatting, length-determination and length-comparison of formatted data until an acceptable result is achieved in said length comparison.

13. The processing device recited in claim 1 wherein said PSE application is configured to create a Tag-Length-Value (TLV) data element by the concatenation of a Tag component, a Length component and a Value component.

14. The processing device recited in claim 13 wherein said PSE application is configured so that the Tag component is equal to a predetermined value associated with the data element in accordance with the EMV standards.

15. The processing device recited in claim 13 wherein said PSE application is configured so that the Length component is equal to a length of the Value component.

16. The processing device recited in claim 13 wherein said PSE application is configured so that the Value component is equal to data retrieved from an EMV payment application and formatted by the PSE application.

17. The processing device recited in claim 13 wherein said PSE application is configured to incorporate the TLV data element into a Data Record.

18. The processing device recited in claim 17 wherein said PSE application is configured so that incorporation of the TLV data element into the Data Record includes the replacement of any existing TLV data element in the Data Record with the TLV data element being incorporated if said TLV data elements have the same Tag component.

19. The processing device recited in claim 17 wherein said PSE application is configured to change length parameters within the Data Record to accurately reflect a new length of the TLV data element being incorporated into the Data Record.

20. The processing device recited in claim 19 wherein said PSE application is configured so that the length parameters changed are those associated with the Application Template (EMV tag ‘61’) and the Payment System Directory Record (EMV tag ‘70’).

21. The processing device recited in claim 4 wherein said PSE application is configured to gather data from multiple EMV payment applications.

22. The processing device recited in claim 7 wherein said PSE application is configured to format data retrieved from multiple EMV payment applications.

23. The processing device recited in claim 13 wherein said PSE application is configured to create multiple Tag-Length-Value (TLV) data components.

24. The processing device recited claim 17 wherein said PSE application is configured to incorporate multiple Tag-Length-Value (TLV) data components into multiple Data Records.

25. A method of providing dynamically updated data in an EMV Application Selection process between a processing device and an interface device (IFD) cooperable therewith, the method comprising receipt of an APPLICATION SELECT command from the Interface Device (IFD) by a Payment System Environment (PSE) application on the processing device, retrieving data associated with a payment application of said processing device, and modifying a constituent Data Record of said PSE application to reflect said retrieved data.

26. A method of providing a dynamic application mnemonic in an EMV transaction between a processing device and an interface device (IFD) cooperable therewith, the method comprising receipt of an APPLICATION SELECT command from the Interface Device (IFD) by a Payment System Environment (PSE) application on the processing device during an EMV Application Selection process, retrieving data associated with a payment application of said processing device, modifying a constituent Data Record of said PSE application to reflect said retrieved data; and issuing the modified Data Record to the IFD in a READ RECORD response in accordance with the EMV Application Selection process.
